(19) United States
(12) Patent Application Publication
(10) Pub. No.: US 2012/0112960 A1
(43) Pub. Date: May 10, 2012

(54) ACCESS POINT, MOBILE TERMINAL, GLOBAL NAVIGATION SATELLITE SYSTEM USING THE ACCESS POINT, AND METHOD OF PROVIDING POSITION INFORMATION USING THE ACCESS POINT

(75) Inventors: In-One Joo, Daejeon-si (KR); Sang-Uk Lee, Daejeon-si (KR)

(73) Assignee: Electronics and Telecommunications Research Institute, Daejeon-si (KR)

(21) Appl. No.: 13/290,771

(22) Filed: Nov. 7, 2011

(30) Foreign Application Priority Data
Nov. 8, 2010 (KR) 10-2010-0110457

(51) Int. Cl. G01S 19/48; G01S 19/25

(52) U.S. Cl. 342/357.31; 342/357.64

(57) ABSTRACT

An access point (AP), a mobile terminal, a global navigation satellite system (GNSS), and a method of providing position information using the AP are provided. The AP may be equipped with or connected to a GNSS receiver, and the GNSS may precisely determine the position of the mobile terminal using auxiliary satellite navigation information that is generated by the GNSS receiver.

### CROSS-REFERENCE TO RELATED APPLICATION(S)

This application claims the benefit under 35 U.S.C. §119(a) of Korean Patent Application No. 10-2010-0110457, filed on Nov. 8, 2010, in the Korean Intellectual Property Office, the entire disclosure of which is incorporated herein by reference for all purposes.

### BACKGROUND

1. Field

The following description relates to satellite communication and position determination techniques, and more particularly, to a satellite navigation technique using an access point (AP).

2. Description of the Related Art

The Global positioning system (GPS) is a currently fully-operational Global Navigation Satellite System (GNSS). GPS was developed by the U.S. Department of Defense and has been widely used for various military and civilian purposes, such as missile guidance, navigation, surveying, map drawing, and the like. With the widespread of GPS receivers, GPS has been increasingly employed in mobile terminals such as a portable multimedia player (PMP), an MP3 player, a mobile phone and the like, and has expanded its application to the fields of location-based services (LBSs), geographical information systems (GISs), moving object tracking and telematics. Most mobile terminals are equipped with a GPS feature, and even a law that makes it mandatory for mobile phones to contain a GPS system has been suggested.

Position determination using GPS is classified into Standalone GPS (S-GPS) and Assisted GPS (A-GPS). S-GPS is a position determination technique using radio signals from satellites alone. A-GPS is a position determination technique additionally using GPS-related auxiliary satellite navigation information from mobile communication base stations.

S-GPS has a long Time-To-First Fix (TTFF) and consumes a relatively large amount of power to determine the position of a terminal. A-GPS can provide better TTFF performance than S-GPS by accessing a mobile communication network to receive GPS-related auxiliary satellite navigation information, and has been widely employed.

However, it generally takes about several minutes after turning on a GNSS function to provide exact position information of a terminal. A-GPS requires a user to access a mobile communication network and thus incurs additional data use charges, thereby making the user reluctant to use a GPS feature.

### SUMMARY

The following description relates to a terminal position determination technique capable of precisely determining the position of a mobile terminal at high speed without incurring additional charges for a user.

In one general aspect, there is provided an access point (AP), including: a satellite navigation signal reception unit configured to receive a satellite navigation signal from a satellite; an auxiliary satellite navigation signal generation unit configured to generate an auxiliary satellite navigation signal based on the satellite navigation signal; and a wireless access unit configured to be connected to a wireless access network and wirelessly transmit the auxiliary satellite navigation signal to a mobile terminal.

In another general aspect, there is provided a mobile terminal, including: a satellite navigation signal reception unit configured to receive a satellite navigation signal from a satellite and receive an auxiliary satellite navigation signal from an AP; and a position determination unit configured to calculate a current position of the mobile terminal based on the satellite navigation signal and the auxiliary satellite navigation signal.

In another general aspect, there is provided a global navigation satellite system (GNSS), including: an AP configured to receive a satellite navigation signal from a satellite and generate an auxiliary satellite navigation signal based on the satellite navigation signal; and a mobile terminal configured to receive the satellite navigation signal from the satellite, receive the auxiliary satellite navigation signal from the AP, and calculate its current position based on the satellite navigation signal and the auxiliary satellite navigation signal.

In another general aspect, there is provided a method of providing position information of a mobile terminal, the method including: receiving a satellite navigation signal from a satellite; receiving an auxiliary satellite navigation signal from an AP; calculating a current is position of the mobile terminal based on the satellite navigation signal and the auxiliary satellite navigation signal; mapping the calculated current position of the mobile terminal on map data and displaying the map data on a screen.

Other features and aspects may be apparent from the following detailed description, the drawings, and the claims.

### BRIEF DESCRIPTION OF THE DRAWINGS

FIG. 1 is a diagram illustrating an example of a Global Navigation Satellite System (GNSS) for determining the position of a mobile terminal using an access point (AP) equipped with a satellite navigation signal reception function.

FIG. 2 is a diagram illustrating an example of an AP equipped with a GNSS.

FIG. 3 is a diagram illustrating an example of a mobile terminal.

FIG. 4 is a flowchart illustrating an example of a method of providing position information of a mobile terminal.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

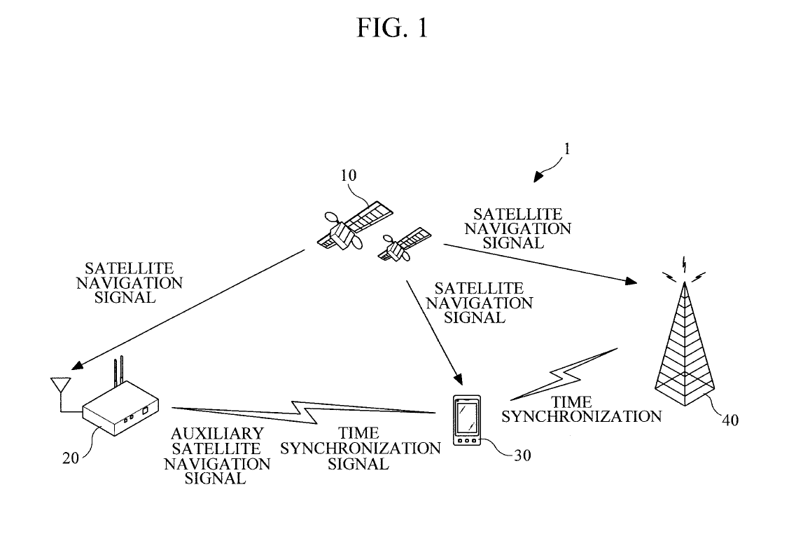

FIG. 1 illustrates an example of a Global Navigation Satellite System (GNSS) for determining the position of a mobile terminal using an AP equipped with a satellite navigation signal reception function.

Referring to FIG. 1, GNSS 1 includes a GNSS satellite 10, an AP 20, a mobile terminal 30, and a mobile communication base station 40.

The GNSS 1 may be a system for keeping track of the position of an object on the ground, for example, a mobile terminal 30, using the GNSS satellite 10. For example, the GNSS 1 may be the GLONASS, the Galileo positioning system, the Global Positioning System (GPS), or the like.

The mobile terminal 30 may include nearly all types of mobile devices such as a portable multimedia player (PMP), an MP3 player, a mobile phone or the like. For example, the mobile terminal 30 may be a smart phone. The AP 20 may provide a free wireless internet access function using a wireless access network. For example, the AP 20 may use the Wireless Fidelity (Wi-Fi) standard. The AP 20 may have a GNSS receiver embedded therein or may be connected to a GNSS receiver. Accordingly, the AP 20 may receive a satellite navigation signal from the GNSS satellite 10. The AP 20 may generally be installed in an indoor environment or anywhere else where it can receive a satellite navigation signal.

The AP 20 may receive a satellite navigation signal from the GNSS satellite 10, may generate an auxiliary satellite navigation signal based on the received satellite navigation signal, and may transmit the auxiliary satellite navigation signal to the mobile terminal 30. The auxiliary satellite navigation signal may include the time of determination of the position of the mobile terminal 30, a navigation message, satellite orbit information, currently-available visible satellite information, the Doppler frequency and code phase time of each visible satellite, carrier phase information, bit synchronization time information, and frame synchronization time information. The AP 20 may generate the auxiliary satellite navigation signal according to a predefined protocol by analyzing bits, codes, and frequency components that constitute the received satellite navigation signal.

The mobile communication base station 40 may receive a satellite navigation signal, and may generate information corresponding to the time of receipt of the satellite navigation signal. The mobile communication base station 40 may provide a time synchronization signal to the mobile terminal 30 so that it can maintain to be time-synchronized with the mobile terminal 30. The mobile communication base station 40 may periodically provide the time synchronization signal to the mobile terminal 30.

In response to a user turning on a GNSS function, including a GPS function, to determine his or her position with the mobile terminal 30, the mobile terminal 30 may receive a satellite navigation signal from the GNSS satellite 10, and may search around for an AP equipped with a GNSS receiver, for example, the AP 20. The mobile terminal 30 may issue a request for an auxiliary satellite navigation and a time synchronization signal to the AP 20, and may receive auxiliary satellite navigation signal and a time synchronization signal from the AP 20. The mobile terminal 30 may calculate its position based on the received auxiliary satellite navigation signal and the received time synchronization signal.

As described above, the mobile terminal 30 may receive an auxiliary satellite navigation signal not from the mobile communication base station 40, but from the AP 20 that is located within the vicinity of the mobile terminal 30. The AP 20 may be only dozens of meters away from the mobile terminal 30, whereas the mobile communication base station 40 may be hundreds or thousands of meters away from the mobile terminal 30.

An auxiliary satellite navigation signal generated by the AP 20 may include not only currently-available visible satellite information, satellite orbit information and Doppler frequency information but also synchronization-related information such as code phase time information. Since the mobile communication base station 40 is about hundreds or thousands of meters away from the mobile terminal 30, synchronization-related information generated by the mobile communication base station 40 may not be precise enough to be used by the mobile terminal 30. In the example illustrated in FIG. 1, the mobile terminal 30 may receive time synchronization-related information from the AP 20 that is located within the vicinity thereof, and may determine its position based on the received time synchronization-related information. Accordingly, it is possible to quickly and precisely determine the position of the mobile terminal 30.

In addition, since, in the example illustrated in FIG. 1, there is no need for a user to access a mobile communication network to receive an auxiliary satellite navigation signal, no additional data use charges may be incurred. Therefore, it is possible to reduce expenses and promote the use of a position determination function.

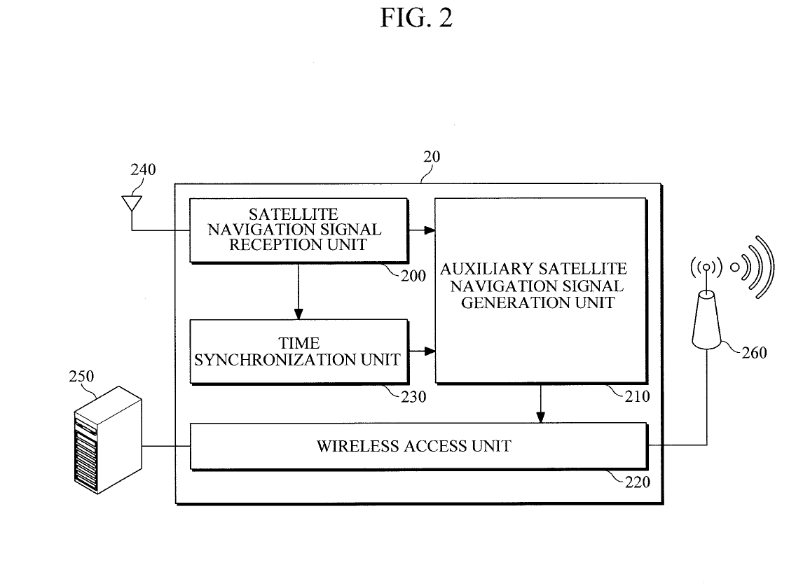

FIG. 2 illustrates an example of an AP equipped with a GNSS receiver.

Referring to FIG. 2, AP 20 includes a satellite navigation signal reception unit 200, an auxiliary satellite navigation signal generation unit 210, a wireless access unit 220, a time synchronization unit 230, and a GNSS antenna 240.

The satellite navigation signal reception unit 200 may process a satellite navigation signal that is received via the GNSS antenna 240, and may provide measurement data and a navigation message that are obtained by the processing to the auxiliary satellite navigation signal generation unit 210 and the time synchronization unit 230. The time synchronization unit 230 may generate time information based on time measurements provided by the satellite navigation signal reception unit 200, and may provide the time information to the auxiliary satellite navigation signal generation unit 210.

An example of maintaining the mobile terminal 30 and the AP 20 to be time-synchronized is described. For example, the mobile communication base station 40 may receive a satellite navigation signal from the GNSS satellite 10, and may provide a time synchronization signal to the mobile terminal 30. As another example, the AP 20 may receive a satellite navigation signal, and may provide a time synchronization signal to the mobile terminal 30.

The auxiliary satellite navigation signal generation unit 210 may generate an auxiliary satellite navigation signal according to a predefined protocol by using the measurement data and the navigation message provided by the satellite navigation signal reception unit 200. The auxiliary satellite navigation signal may include position determination time information, a navigation message, satellite orbit information, currently-available visible satellite information, the Doppler frequency and code phase time of each visible satellite, carrier phase information, bit synchronization time information, and frame synchronization time information. The wireless access unit 220 may be connected to a wireless access network 250, and may transmit the auxiliary satellite navigation signal and a time synchronization signal via a wireless communication means, for example, Wi-Fi.

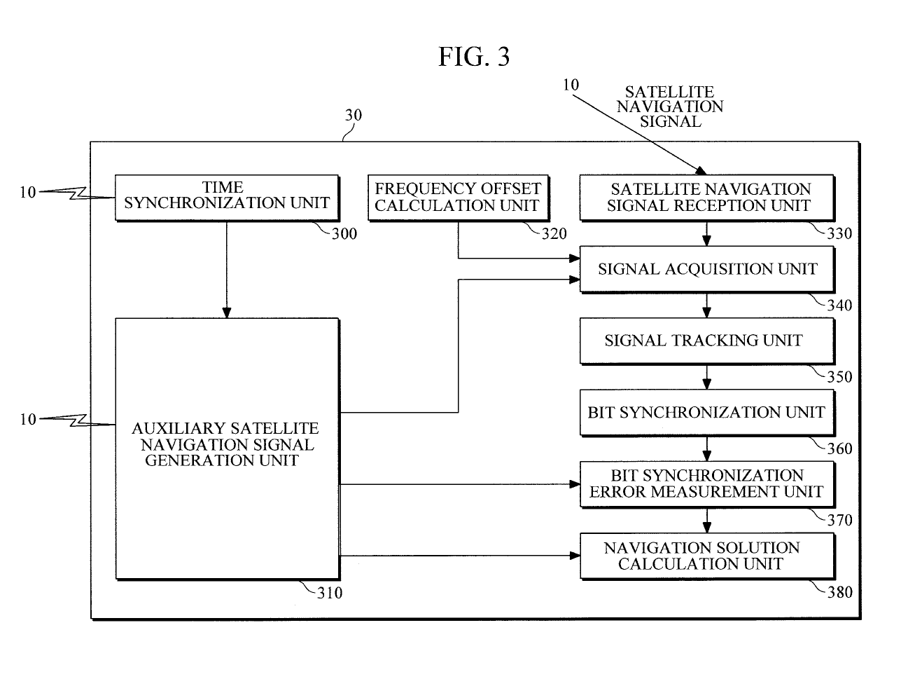

FIG. 3 illustrates an example of the mobile terminal 30.

Referring to FIG. 3, mobile terminal 30 includes a time synchronization unit 300, an auxiliary satellite navigation signal reception unit 310, a terminal clock frequency offset calculation unit 320, a satellite navigation signal reception unit 330, a signal acquisition unit 340, a signal tracking unit 350, a bit synchronization unit 360, a bit synchronization error measurement unit 370, and a navigation solution calculation unit 380.

The time synchronization unit 300 may receive a time synchronization signal from the is AP 20 or the mobile communication base station 40, and may transmit terminal time information to the auxiliary satellite navigation signal reception unit 310. In response to the mobile terminal 30 turning on a GNSS function, the auxiliary satellite navigation signal reception unit 310 may issue a request for an auxiliary satellite navigation signal to the AP 20, and may receive an auxiliary satellite navigation signal from the AP 20.

An example of the mobile terminal 30 processing a satellite navigation signal using an auxiliary satellite navigation signal is described. In response to a satellite navigation signal being received, the satellite navigation signal reception unit 330 may provide code phase synchronization time information to the signal acquisition unit 340 based on currently-available GNSS visible satellite information and the Doppler frequency of each visible satellite, current terminal information, and code phase time information.

The terminal clock frequency offset calculation unit 320 may calculate the offset between a reference frequency and a clock frequency that is used in the mobile terminal 30 while the mobile terminal 30 is active, and may provide a clock frequency offset obtained by the calculation to the signal acquisition unit 340.

The signal acquisition unit 340 may determine a corrected Doppler frequency by adding the clock frequency offset and a received Doppler frequency, and may acquire visible satellite information and a received code phase synchronization time. The received code phase synchronization time may be erroneous due to the mobile terminal 30 and the AP 20 being time-synchronized within a predetermined range of errors. Therefore, an actual code phase value may be determined by searching for the code phase synchronization time. In response to the actual code phase value being determined, the signal acquisition unit 340 may transmit the actual code phase value to the signal tracking unit 350 along with the visible satellite information and the corrected Doppler frequency.

The signal tracking unit 350 may accumulate values provided by the signal acquisition unit 340 by using a correlator, and the bit synchronization unit 370 may measure a bit synchronization time based on the result of the accumulation. The bit synchronization error measurement unit 370 may calculate a bit synchronization error time that is the difference between the measured bit synchronization time and a bit synchronization time received by the auxiliary satellite navigation signal reception unit 310. The bit synchronization error time may occur due to the mobile terminal 30 and the AP 20 being time-synchronized within a predetermined range of errors.

The navigation solution calculation unit 380 may receive an auxiliary satellite navigation signal, including a navigation message, satellite orbit information, carrier phase information, position determination time information, and frame synchronization time information, from the auxiliary satellite navigation signal reception unit 310, and may precisely calculate a current position of the mobile terminal 30 at high speed based on the received auxiliary satellite navigation signal and the bit synchronization error time.

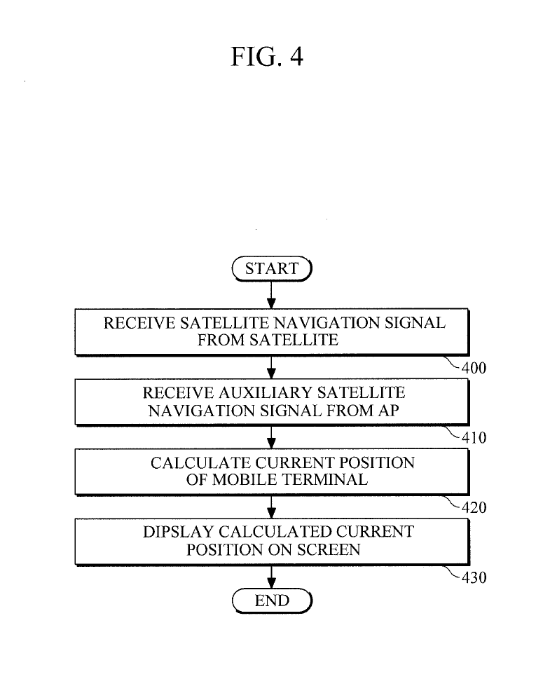

FIG. 4 illustrates an example of a method of providing position information of the mobile terminal 30.

Referring to FIGS. 1 and 4, in 400, the mobile terminal 30 may receive a satellite navigation signal from the GNSS satellite 10. In 410, the mobile terminal 30 may receive an auxiliary satellite navigation signal from the AP 20.

In 420, the mobile terminal 30 may calculate its current position based on the received satellite navigation signal and the received auxiliary satellite navigation signal. In 430, the calculated current position of the mobile terminal 30 may be mapped on map data, and the map data may be displayed on the screen of the mobile terminal 30.

For example, in 410, the mobile terminal 30 may determine a corrected Doppler frequency using a clock frequency offset and a received Doppler frequency. The mobile terminal 30 may determine a code phase synchronization time and an actual code phase value based on terminal time information thereof and received code phase time information. The mobile terminal 30 may determine a bit synchronization time by accumulating the determined corrected Doppler frequency, the determined code phase synchronization time, and the determined actual code phase value. The mobile terminal 30 may calculate a bit synchronization error time that is the difference between the determined bit synchronization time and a received bit synchronization time. The mobile terminal 30 may calculate its current position based on a navigation message, satellite orbit information, carrier phase information, position determination time information, and frame synchronization time information that are included in the auxiliary satellite navigation signal and based on the bit synchronization error time.

The mobile terminal 30 may determine whether its calculated current position is valid. In response to the calculated current position of the mobile terminal 30 being valid, the mobile terminal 30 may display its calculated current position on its screen. On the other hand, in response to the calculated current position of the mobile terminal 30 not being valid, the mobile terminal 30 may receive another auxiliary satellite navigation signal from the AP 20, and may perform operations 400, 410, 420, and 430 again based on the received auxiliary satellite navigation signal.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As described above, it is possible to precisely determine the position of a mobile terminal at high speed by using an auxiliary satellite navigation signal that is received not from a mobile communication base station, but from an AP that is located within the vicinity of the mobile terminal.

In addition, since the auxiliary satellite navigation signal includes visible satellite information, satellite orbit information, satellite Doppler frequency information and time synchronization-related information (such as code phase time information), it is possible to precisely determine the position of a mobile terminal at high speed based on the time synchronization-related information.

Moreover, it is possible to receive the auxiliary satellite navigation signal without the need to access a mobile communication network. Therefore, it is possible to reduce expenses and promote the use of position determination by not incurring additional data use charges.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An access point (AP), comprising:
a satellite navigation signal reception unit configured to receive a satellite navigation signal from a satellite;
an auxiliary satellite navigation signal generation unit configured to generate an auxiliary satellite navigation signal based on the satellite navigation signal; and
a wireless access unit configured to be connected to a wireless access network and wirelessly transmit the auxiliary satellite navigation signal to a mobile terminal.

2. The AP of claim 1, wherein the auxiliary satellite navigation signal comprises at least one of position determination time information, a navigation message, satellite orbit information, currently-available visible satellite information, satellite Doppler frequency information, code phase time information, carrier phase information, bit synchronization time information, and frame synchronization information.

3. The AP of claim 1, wherein the auxiliary satellite navigation signal generation unit is configured to generate the auxiliary satellite navigation signal according to a predefined protocol by analyzing bits, codes, and frequency components that constitute the satellite navigation signal.

4. The AP of claim 1, further comprising:
a time synchronization unit configured to generate, based on the satellite navigation signal, a time synchronization signal for time-synchronizing the AP with the mobile terminal,
wherein the wireless access unit is configured to wirelessly transmit the time synchronization signal to the mobile terminal.

5. A mobile terminal, comprising:
a satellite navigation signal reception unit configured to receive a satellite navigation signal from a satellite and receive an auxiliary satellite navigation signal from an AP; and
a position determination unit configured to calculate a current position of the mobile terminal based on the satellite navigation signal and the auxiliary satellite navigation signal.

6. The mobile terminal of claim 5, wherein the auxiliary satellite navigation signal comprises at least one of position determination time information, a navigation message, satellite orbit information, currently-available visible satellite information, satellite Doppler frequency information, code phase time information, carrier phase information, bit synchronization time information, and frame synchronization information.

7. The mobile terminal of claim 6, wherein the position determination unit comprises:
a signal acquisition unit configured to determine a corrected Doppler frequency based on a clock frequency offset of the mobile terminal and the satellite Doppler frequency information and determine a code phase synchronization time and an actual code phase value based on the code phase time information;
a signal tracking unit configured to accumulate the corrected Doppler frequency, the code phase synchronization time, and the actual code phase value that are determined by the signal acquisition unit;
a bit synchronization unit configured to determine a bit synchronization time based on a value obtained by the accumulation performed by the signal tracking unit;
an error measurement unit configured to calculate a bit synchronization error time that is a difference between the determined bit synchronization time and a received bit synchronization time provided by the signal reception unit; and
a current position calculation unit configured to calculate the current position of the mobile terminal based on the position determination time information, the navigation message, the satellite orbit information, the carrier phase information, the frame synchronization time information and the calculated bit synchronization error time.

8. The mobile terminal of claim 5, further comprising:
a time synchronization signal reception unit configured to receive a time synchronization signal for time-synchronizing the mobile terminal with the AP from the AP or a mobile communication base station.

9. A global navigation satellite system (GNSS), comprising:
an AP configured to receive a satellite navigation signal from a satellite and generate an auxiliary satellite navigation signal based on the satellite navigation signal; and
a mobile terminal configured to receive the satellite navigation signal from the satellite, receive the auxiliary satellite navigation signal from the AP, and calculate its current position based on the satellite navigation signal and the auxiliary satellite navigation signal.

10. A method of providing position information of a mobile terminal, the method comprising:
receiving a satellite navigation signal from a satellite;
receiving an auxiliary satellite navigation signal from an AP;
calculating a current position of the mobile terminal based on the satellite navigation signal and the auxiliary satellite navigation signal;
mapping the calculated current position of the mobile terminal on map data and displaying the map data on a screen.

11. The method of claim 10, wherein the calculating the current position of the mobile terminal, comprises:
determining a corrected Doppler frequency based on a clock frequency offset of the mobile terminal and satellite Doppler frequency information included in the auxiliary satellite navigation signal and determining a code phase synchronization time and an actual code phase value based on time information of the mobile terminal and code phase time information included in the auxiliary satellite navigation signal;
determining a bit synchronization time by accumulating the corrected Doppler frequency, the determined code phase synchronization time, and the determined actual code phase value;
calculating a bit synchronization error time that is a difference between the determined bit synchronization time and a received bit synchronization time included in the auxiliary satellite navigation signal; and
calculating the current position of the mobile terminal based on position determination time information, a navigation message, satellite orbit information, carrier phase information, and frame synchronization time information that are included in the auxiliary satellite navigation signal and based on the calculated bit synchronization error time.

12. The method of claim 10, further comprising:
determining whether the calculated current position of the mobile terminal is valid; and
displaying the calculated current position of the mobile terminal on the screen in response to the calculated current position of the mobile terminal being valid, and receiving another auxiliary satellite navigation signal from the AP in response to the calculated current position of the mobile terminal being determined not to be valid.
